(19) United States
(12) Patent Application Publication
(10) Pub. No.: US 2007/0267784 A1
(43) Pub. Date: Nov. 22, 2007

(54) Method for the Manufacturing of a Three-Dimensional Object in a Layer-Wise Fashion and Material Systems Suitable Therefor

(76) Inventor: Ralph Greiner, Leonberg (DE)

Correspondence Address: CHRISTIE, PARKER & HALE, LLP, PO BOX 7068, PASADENA, CA, 91109-7068, US

(21) Appl. No.: 10/586,081

(22) PCT Filed: Jan. 21, 2005
(86) PCT No.: PCT/EP05/00603

§ 371 Date: Jul. 23, 2007

(30) Foreign Application Priority Data
Jan. 23, 2004 (DE) 10 2004 003 485.0

(51) Int. Cl. B29C 67/00

(52) U.S. Cl. 264/497; 425/87; 428/546

(57) ABSTRACT

The dimensions of objects produced by means of layer-structuring methods keep increasing while said objects get heavier and are thus less easy to handle and transport. Fine structures can even break off the whole body as a result of the intrinsic weight thereof. The aim of the invention is therefore to create a layer-structuring method for producing a three-dimensional object as well as suitable material systems which improve the manageability and transportability thereof without imposing substantial restrictions regarding the variety of selectable materials and the stability of the components. Said aim is achieved by using particles that contain at least one cavity, whereby the solid body volume and thus the weight is reduced compared to massive particles without substantially reducing stability.

The invention relates to a Method for the manufacturing of a three-dimensional-object in a layer-wise fashion and material systems suitable therefor according to the preamble of claims 1, 2, 4, and 5, and an object manufactured with this method according to claim 9. Methods and material systems of this type are known from DE 101 08 612 C1 and DE 100 26 955 A1.

Methods for the manufacturing of three-dimensional-objects in a layer-wise fashion are finding increasing fields of application, in particular in: rapid prototyping, rapid tooling, and rapid manufacturing. Methods of this type can be liquid-based, e.g. stereolithography, powder-based, e.g. laser sintering or 3D printing, or solid layer-based, e.g. laminated object manufacturing.

What is common to all these methods is that with increasing broadening of the application fields, the dimensions of the objects manufactured with them also keep increasing. In addition, the objects are becoming heavier and therefore more difficult to handle and to transport. Finer structures may even break off from the overall body due to their weight.

It is therefore the object of the present invention to provide a method for the manufacturing of a three-dimensional object in a layer-wise fashion and suitable material systems that improve the handling and transport features thereof while placing no significant restriction on the great variety of selectable materials and the stability of the components.

This object is solved by using particles that contain at least one cavity. This reduces the volume of solid matter and therefore the weight as compared to massive particles without significantly reducing the stability.

Particles of this type can be manufactured cost-efficiently from microporous materials, e.g. activated carbon or zeolites, on an industrial scale and at particle size distributions that are suited to said methods by means of comminution or newly built-up, for example emulsion polymerization can be used to manufacture hollow beads in the range of micrometers or below on an industrial scale. Industrially manufactured hollow beads can either be suitable particles as such or serve for the manufacture thereof, by building up, for example, agglomerates of multiple hollow beads or of at least one hollow bead and at least one massive particle to form suitable particles. Suitable particle size distributions can be attained by known procedures, e.g. screening, sifting.

As the material of such particles, any material with cavities of a suitable dimension that occurs naturally or can be manufactured is suitable, e.g. metals, ceramics or plastics.

With regard to the method to be created, the invention is represented by the features of claim 2, and with regard to the material to be created, the invention is represented by claims 4 and 5. The further claims contain advantageous further developments and refinements of the method and material according to the invention (claims 3 and 6 to 8) as well as an object manufactured by means of the method and materials according to the invention (claim 9).

With regard to the method to be created, the object is solved according to the invention by carrying out the following steps:
applying a layer of particles onto a target surface;
irradiating a selected part of the layer that corresponds to a cross-section of the object with a beam of energy or a jet of liquid such that the particles in the selected part become connected to each other;
repeating the steps of application and irradiation with a beam or jet for a multiplicity of layers such that the connected parts of adjacent layers connect to each other to form the object,
   wherein
particles are used that contain at least one cavity.

In this context, the beam of energy can be of any type, e.g. an electron beam or IR beam, preferably a laser beam, provided the energy input into the particle layer is sufficiently high in order to effect connection of the particles. For this purpose, it is not necessary for the particles in the irradiated area to melt completely. Initial melting or initiation of a chemical reaction by the energy can also be sufficient.

With regard to a liquid being used, at least one component of the particles must be soluble therein or a reaction must be initiated due to the interaction with the liquid such that the particles in the area of impact of the liquid are made to connect to each other. The term, jet of liquid, shall comprise not only a continuous jet, but also individual drops.

In an advantageous further development of the method, the irradiation of the particles to a beam or jet is carried out such that the cavities are essentially preserved. For this purpose, it is sufficient to limit the input of energy or liquid such that only superficial connection of the particles without complete melting or dissolution thereof is effected.

With regard to the material system to be created, in particular for use in 3D printing, the object is solved according to the invention in that it contains solid particles and a liquid, wherein at least parts of the particles possess the feature of forming lasting connections to adjacent particles upon exposure to the liquid, wherein the particles contain at least one cavity.

A material system of this type allows the methods described above to be used to build-up three-dimensional objects that possess comparable features as objects built up from massive particles, but are significantly lighter in weight and thus easier to handle.

The lasting connection can be formed by at least part of the particles (e.g. a coating) being, for example, dissolved, induced to react or partly-melted by the liquid upon exposure to the liquid.

A suitable material system for use in laser sintering (also called selective laser sintering) consists of particles that comprise at least on a part of their surface a component whose softening temperature is below 100° C. and contain at least one cavity.

Materials with a softening temperature of this type can include alloys that are used, for example, in fusible links (compare e.g. JP2001143588A), as well as linear carbonic acids with a chain length ≧16 (e.g. heptadecanoic acid, melting point 60-63° C.) or polymers in the broadest sense.

Particles of this type can be processed rapidly and precisely with common laser sintering facilities and objects made therefrom possess good handling features because of the cavities.

In the material systems mentioned above, it is advantageous for the size distribution curves of the particles to have centers of gravity at diameters of less than 500 μm, preferably at diameters on the order of 10 to 300 μm. Particle sizes of this type can be used to cover virtually all requirements of the application fields known at this time. Strict precision requirements necessitate that the particle size distribution shows little variation and may require small diameters near the lower threshold mentioned above.

In addition, it is advantageous for said material systems if the volume fraction of the cavities of the particles accounts for minimally 30% and maximally 90%, preferably minimally 50% and maximally 80%, of the volume of the particles.

Depending on the material used, this allows for sufficient stability of the objects thus produced to be attained while their weight is kept low and the handling features are good.

It is advantageous for said material systems if the particles comprise cross-linkable polymers at least on their surface. These can be provided, for example, in the form of a coating. Cross-linking can be initiated by exposure to energy or by the liquid and lead to the formation of a lasting connection to adjacent particles.

In the following, the method according to the invention and the material systems according to the invention are illustrated in more detail by means of two exemplary embodiments:

A suitable material system for laser sintering contains particles made from naturally occurring volcanic zeolites that have been comminuted and screened to posses a diameter distribution with a main emphasis at 100 μm. Their porosity is approx. 45% from which results a reduction of the actual density from 2.5 g/cm³ to apparent 1.4 g/cm³. Mineralogical ingredients: mainly clinoptilolite and mordenite. Chemical composition: mainly SiO₂ and Al₂O₃.

These particles were provided with a polyvinyl butyral coating, which has a softening temperature of approx. 66° C., by means of the known fluidized bed procedure (compare DE 10313452 A1).

The coated particles are applied layer by layer to a target surface, a selected part of the layer that corresponds to a cross-section of the object is irradiated with a laser beam such that the particles in the selected part become connected to each other, then the steps of application and irradiation with the beam are repeated for a multiplicity of layers such that the connected parts of adjacent layers connect to each other in order to form the object.

The laser beam (power 10 Watt (or less if the stability requirements are less stringent), feed rate≈5 m/s, laser spot diameter≈0.4 mm) is guided such that the radiation energy thus coupled-in causes the coating to soften and therefore causes the irradiated particles to connect to each other without melting the core material. The coating is approx. 0.3 to 0.7 μm in thickness.

A suitable material system for 3D printing contains particles made from hollow PMMA beads that were made by emulsion polymerization and coated with polyvinylpyrrolidone (PVP) by means of the fluidized bed procedure. The coating is approx. 0.3 to 0.7 μm in thickness. The diameter distribution of the particles has its main emphasis at 50 μm. The material system contains water as liquid component. PVP is soluble in water.

The coated particles are applied layer by layer onto a target surface, a selected part of the layer that corresponds to the cross-section of the object is irradiated with drops of water such that particles in the selected part become connected to each other, then the steps of application and irradiation are repeated for a multiplicity of layers such that the connected parts of adjacent layers connect to each other in order to form the object.

In the embodiments of the examples described above, the method according to the invention and the material systems according to the invention prove to be particularly well-suited for rapid prototyping, rapid tooling, and rapid manufacturing applications in the automotive industry.

In particular, they allow a clear improvement in the handling features and stability of large fine-detailed structures to be attained.

The invention shall not be limited to the exemplary embodiments illustrated above, but rather is applicable to other exemplary embodiments as well.

As such, it is conceivable, for example, that the cavities of the particles are filled with a medium that is lighter-weight as compared to the cavity wall, e.g. a liquid or a gas.

Particles in the form of hollow metallic beads can be used as well. These can be manufactured by the fluidized bed procedure by, for example, spraying a binder-metal powder-suspension onto styrofoam beads and heating sufficiently for the metal powder to melt and form a solid surface, while the styrofoam evaporates. The resulting surface can be closed or porous.

1. Use of particles containing at least one cavity in the method for the manufacturing of a three-dimensional object in a layer-wise fashion.

2. Method for the manufacture of a three-dimensional object comprising the following steps:
applying a layer of particles onto a target surface;
irradiating a selected part of the layer that corresponds to a cross-section of the object with a beam of energy or a jet of liquid such that the particles in the selected part become connected to each other;
repeating the steps of application and irradiation with a beam or jet for a multiplicity of layers such that the connected parts of adjacent layers connect to each other to form the object,
characterized in that particles are used that contain at least one cavity.

3. Method according to claim 2,
characterized in that
the particles are irradiated such that the cavities are essentially preserved.

4. Multiple-phase material system for use in 3D printing containing solid particles and a liquid;
wherein at least parts of the particles possess the feature to form lasting connections to adjacent particles upon contact with the liquid,
characterized in that the particles contain at least one cavity.

5. Particle for use in laser sintering comprising on at least part of its surface a component whose softening temperature is below 100° C.,
characterized in that
it contains at least one cavity.

6. Material system according to claim 4,
characterized in that
the particles have diameters of less than 500 μm, preferably diameters on the order of 10 to 300 μm.

7-9. (canceled)

10. Particle according to claim 5,
characterized in that the particle has a diameter of less than 500 μm, preferably a diameter on the order of 10 to 300 μm.

11. Material system according to claim 4,
characterized in that the volume fraction of the cavities accounts for minimally 30% and maximally 90%, preferably at least 50% and maximally 80%, of the volume of the particles.

12. Particle according to claim 5,
characterized in that the volume fraction of the cavities accounts for minimally 30% and maximally 90%, preferably at least 50% and maximally 80%, of the volume of the particle.

13. Material system according to claim 6,
characterized in that the volume fraction of the cavities accounts for minimally 30% and maximally 90%, preferably at least 50% and maximally 80%, of the volume of the particles.

14. Particle according to claim 10,
characterized in that the volume fraction of the cavities accounts for minimally 30% and maximally 90%, preferably at least 50% and maximally 80%, of the volume of the particle.

15. Material system according to claim 4,
characterized in that the particles comprise cross-linkable polymers at least on their surface.

16. Particle according to claim 5,
characterized in that the particle comprises cross-linkable polymers at least on its surface.

17. Material system according to claim 6,
characterized in that the particles comprise cross-linkable polymers at least on their surface.

18. Particle according to claim 10,
characterized in that the particles comprise cross-linkable polymers at least on their surface.

19. Object made of particles that are connected to each other,
characterized in that it was manufactured by means of a method according to claim 2.

20. Object made of particles that are connected to each other,
characterized in that it was manufactured by means of a method according to claim 3.

21. Object made of particles that are connected to each other,
characterized in that it was manufactured from a material system according to claim 4.

22. Object made of particles that are connected to each other,
characterized in that it was manufactured from particles according to claim 5.
